(19) United States
(12) Patent Application Publication
(10) Pub. No.: US 2018/0356045 A1
(43) Pub. Date: Dec. 13, 2018

(54) HYDROCARBON-BASED VISCOSITY ENHANCERS AND PRODUCTIVE CAPACITY RESTORERS CROSS-REFERENCE TO RELATED APPLICATIONS

(71) Applicant: JANUS CAPITAL MEDITERRANEO S.R.L., San Jose (CR)

(72) Inventors: James D. Rogerson, San Jose (CR); Augustinus W.M. Roes, Kuala Lumpur (MY)

(21) Appl. No.: 15/963,645

(22) Filed: Apr. 26, 2018

Related U.S. Application Data
(60) Provisional application No. 62/490,411, filed on Apr. 26, 2017.

(51) Int. Cl. F17D 1/16

(52) U.S. Cl. CPC F17D 1/16

(57) ABSTRACT

A composition for reducing the viscosity of a fluid comprising an alkane component and an aromatic hydrocarbon component.

### CROSS-REFERENCE TO RELATED APPLICATIONS

This application, claims the benefit of U.S. Provisional Patent Application No. 62/490,411, filed Apr. 26, 2017, entitled “Diluent Enhancement and Pipeline Capacity Restorers,” the entire contents and substance of which are hereby incorporated by reference as if fully set forth below.

### TECHNICAL FIELD

The invention generally relates to hydrocarbon-based viscosity enhancer compositions that can comprise an alkane component and an aromatic hydrocarbon component. The compositions can be used as additives to heavy oil, or can be added to light oil condensate diluents.

### BACKGROUND

In North America (and around the globe), pipeline construction is not keeping up with expansion of the oils sands mining, steam-assisted gravity drainage (SAGD) projects, and other heavy oil extraction techniques. Currently producers use condensate (diluent) gathered from various light oil fields, including those located in Alberta, to dilute the heavy crude oil so that is will meet pipeline specification and ultimately flow freely in pipelines, such as Western Canadian Select. Sources of the diluents include the Beaver Hill Lakes, Bigstone, Devon, Unicol, Gold Creek, Pass Creek, Tony Creek, Snipe Lake and plays such as the Montney plays, Duvernay plays and other fields. One clear reaction of increased heavy oil prices is that the “light” condensate oil supply is becoming gradually heavier due to the economic advantages drillers are experiencing from producing heavy oils. The industry swing from production of 680 kg/m³ oil to heavier 800+kg/m³ specific gravity ultimately means less effective diluent which industry wide translates in to a necessity of greater dilution being necessary.

The diluents currently used are from routine bulk production facilities and their compositions, although monitored and somewhat regulated, are not specifically designed to reduce viscosity in specific oils. Chemicals, polymers and drag reducing agents (DRAs) are used in pipelines to try to allow oil to flow but generally they cause fowling of upstream processes, process equipment, and vessels, especially where heat or pressure is used to refine or separate product. Polymers and chemicals are used to clean and wash vessels, but many are water-based and cause emulsion problems in pipelines and process vessels.

Heavy oil producers are currently using approximately one barrel of condensate for the transportation and upgrading of two barrels of oil. With the oils sands production proposed to climb from the current 1.8 million barrels of oil in 2013 to an estimated 5.3 million barrels by 2020, it would mean an increased usage of 1.2 million barrels of condensate diluent. This predicted steep increase in demand for light oils has and will continue to make light oils a sought-after commodity. Although industry groups have developed elaborate extraction processes and transportation systems focused on the recycling of these diluent hydrocarbons, the oil industry as a whole has not yet escaped the high cost of recycled transportation or the inevitable high percentage losses that happen during the refining process.

Crude oil is a collection or spectrum of different molecules. Oil removed from oil sands and other bitumen operations contain several components including carbon, sulfur, oxygen, hydrogen, water, acids, bases, olefins, cycloaromatics and salts. Carbon chains can range in length from single carbons to that of long chain hydrocarbons in excess of 150 carbons. Oil is a dynamic fluid which is constantly evolving in reservoir. Crude oils in separate reservoirs are as unique as finger prints and are in unique stages of decomposition, more specifically understood as slow thermal maturation. The very elements and paramagnetic species that make up the oil act as catalysts and radicals to decompose it into a simpler shorter chain, more volatile product. The most dense and viscous oils contain asphaltenes that form highly stable nanoparticles within oil due to the types of bonding (acid base interactions, hydrogen bonding, coordination complexes, associated molecular groups and aromatic stacking) that they undergo. These large highly stable molecules ultimately can seal up reservoir seams, impede pipe in production and upgrading facilities and ultimately reduce flow in the large continental pipelines.

Diluent is often added to the heavy oils to reduce the viscosity but there has been industrial usage of polymers or other elemental or surfactant based compounds to achieve viscosity benefits. Generally, these compounds are known as drag reducing agents (DRAs). This general technique of adding non-like compounds, however, is best described as “chemical warfare”. These chemical cocktails interact in pipes and processing facilities, corroding pipelines, vessels sometimes destroying compressors, fouling process towers, pumps and large scale production equipment. This warfare leads to pipeline integrity and corrosion issues which are ultimately precursors to pipeline failures and environmental damage.

For example, currently producers in Alberta are adding between 6% and 33% diluent to their heavy production oils in order to get them to flow and meet pipeline specifications. This means that these pipelines have 6-33% less oil in them than they could. When oil is not being shipped on the pipeline, it is being hauled in trucks or shipped in overland train cars. Shipping off the pipeline is not only not as cost effective as pipeline shipping, but also has more inherent environmental risk and translates into greater risk to the public. The public is showing increased concern regarding transportation of heavy oil through populated areas and environmentally sensitive areas. In recent times, oil platform failures, train derailments and pipeline corrosion failures have been gaining more and more media attention. As oil production across the world, for example, in northern Alberta, ramps up to meet needs, proposals to simultaneously increase the size of pipeline transportation systems has been slowed. This means that with every month there are more trains and more trucks carrying crude oil across and through public infrastructure. The use of excessive amounts of diluent is wasteful, uneconomical, produces excess environmental footprint, and ultimately “wastes” a non-renewable resource.

Thus, there is a need for technology that specifically engineers a diluent that can be used at lower volumes to provide the same flow characteristics within a pipe such that the efficiency existing transportation systems can be increased. Such a technology can provide more room in the pipeline, fewer trucks on public roads, less environmental impact, and fewer train cars to ship the same dollars of oil and could ultimately cause a dynamic shift in the way oil is priced.

### SUMMARY

Some embodiments of the present disclosure can be a composition for reducing the viscosity of a fluid. In some embodiments, the composition can comprise: an alkane component, the alkane component can at least one C-5 to C-7 alkane; and an aromatic hydrocarbon component, the aromatic hydrocarbon component can comprise at least one aromatic hydrocarbon. In some embodiments, an alkane component:aromatic hydrocarbon component ratio is from about 5:6 to about 66:1.

In some embodiments, the composition can comprise: pentane; hexane; and an aromatic hydrocarbon component, and the aromatic hydrocarbon component can comprise toluene and xylene. In some embodiments, the a pentane:hexane:toluene:xylene ratio can be from about 27:39:2:1 to about 37:49:5:4. In some embodiments, the pentane:hexane:toluene:xylene ratio can be 8:11:3:1. In some embodiments, the composition can further comprise benzene and ethylbenzene, wherein a pentane:hexane:benzene:toluene:ethylbenzene:xylene ratio can be from about 27:39:1:1:1:1 to about 37:49:2:2:2:2. In some embodiments, the pentane:hexane:benzene:toluene:ethylbenzene:xylene ratio can be about 8:11:1:1:1:1.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Embodiments of the present disclosure include compositions and methods for reducing the viscosity of a fluid. The fluid can be, for example, a light oil condensate diluent or a heavy oil, e.g., an in situ oil or crude oils, and the like. The compositions can be an additive to heavy oil directly, or an additive to a light oil condensate diluent, which can then be added to a heavy oil. The compositions can alter the viscosity of heavy oils, bitumen, and sludge oils such that they will flow.

The compositions can accentuate the C-4 to C-10 behavior and character of condensate diluents, make them more effective, and thus less diluent can be used and more oil can travel in a pipeline within the specific pipeline specification. The compositions can have viscosity reducing capabilities such that the overall amount of diluent in a heavy oil (e.g., a crude oil) can be decreased. Such a decrease in overall amount of diluent can, for example, increase the amount of crude oil through a pipeline, which can in turn result in an overall increase in productive capacity through the pipeline. Accordingly, the compositions can provide increased oil in pipelines, which can result in a decreased carbon footprint in shipping oil in pipeline rather than by rail or tuck, which can reduce environmental risks. The compositions can also decrease plugging or unplug lines in upstream, downstream and midstream.

In some embodiments, the composition for reducing the viscosity of a fluid can comprise an alkane component in certain ratios with an aromatic hydrocarbon component. One advantage of certain embodiments of the present disclosure is using “like” chemicals in the compositions, e.g., hydrocarbon-based chemicals, solves the problems associated with non-like compounds, e.g., corrosion and clogging. The ratio of alkane component to aromatic hydrocarbon component can be formulated to specifically manipulate the intermolecular interactions of the alkane components and aromatic hydrocarbon components that are already present in the parent diluent and/or heavy oil. Without wishing to be bound by theory, it is thought that once the nature of the specific heavy oil of interest is understood, it can be considered in a mathematical context with its condensate diluent and accordingly, ideal ratios for the various components in the disclosed compositions can be derived for any heavy oil. Accordingly, one advantage of the present disclosure is the ability to derive formulations that meet specified pipeline specifications. Such a formulation can be derived utilizing a predictive viscosity calculation that accounts for densities of the parent heavy oil and specific light oil condensate.

In some embodiments, the compositions can comprise an alkane component. The alkane component can comprise a single alkane, or multiple alkanes with varying carbon chain lengths. A person of ordinary skill in the art would know that an alkane is an acyclic branched or unbranched hydrocarbon having the general formula CnH₂ₙ₊₂, and therefore an alkane consists entirely of hydrogen atoms and saturated carbon atoms. In some embodiments, the alkane component can comprise at least one C-5 to C-16 alkane (where the “C” stands for carbon and the number corresponds to the number of carbon atoms in the alkane, e.g., C-5 is a 5-carbon alkane with the formula C₅1112). In some embodiments, the alkane component can comprise at least one C-5 to C-10 alkane. In some embodiments, the alkane component can comprise at least one C-5 to C-8 alkane. In some embodiments, the alkane component can comprise at least one C-5 to C-7 alkane. In some embodiments, the alkane component can comprise three alkanes, for example, a C-5 alkane, a C-6 alkane, and a C-7 alkane. In some embodiments, the alkane component can comprise a C-6 alkane, a C-7 alkane, and a C-8 alkane. In some embodiments, the alkane component can comprise two alkanes, for example, a C-5 alkane and a C-6 alkane. In some embodiments, the alkane component can comprise a C-5 alkane and a C-7 alkane. In some embodiments, the alkane component can comprise a C-6 alkane and a C-7 alkane. In some embodiments, the alkane component can consist of a C-5 alkane and a C-6 alkane. In some embodiments, the alkane component can comprise a single alkane, for instance, a C-5 or a C-6 alkane.

In some embodiments, the C-5 alkane can be pentane (i.e., n-pentane). In some embodiments, the C-5 alkane can be pentane, isopentane, neopentane, or combinations thereof (that is, the alkane can comprise multiple isomers).

In some embodiments, the C-6 alkane can be hexane (i.e., n-hexane). In some embodiments, the C-6 alkane can be 2-methylpentane, 3-methylpentane, 2,2-dimethylbutane, and 2,3-dimethylbutane, or combinations thereof.

In some embodiments, the C-7 alkane can be heptane (i.e., n-heptane). In some embodiments, the C-7 alkane can be 2-methylhexane (i.e., isoheptane), 3-methylhexane, 2,2-dimethylpentane (i.e., neoheptane), 2,3-dimethylpentane, 2,4-dimethylpentane, 3,3-dimethylpentane, 3-ethylpentane, 2,2,3-trimethylbutane (i.e., triptane), or combinations thereof.

In some embodiments, the C-8 alkane can be octane (i.e., n-octane). In some embodiments, the C-8 alkane can be a structural or stereoisomer of octane, or mixtures thereof, including, but not limited to, isooctane. In some embodiments, the C-9 alkane can be nonane (i.e., n-nonane). In some embodiments, the C-9 alkane can be a structural or stereoisomer of nonane, or mixtures thereof. In some embodiments, the C-10 alkane can be decane (i.e., n-decane). In some embodiments, the C-10 alkane can be a structural or stereoisomer of decane, or mixtures thereof. In some embodiments, the C-11 alkane can be undecane (i.e., n-undecane). In some embodiments, the C-11 alkane can be a structural or stereoisomer of undecane, or mixtures thereof. In some embodiments, the C-12 alkane can be dodecane (i.e., n-dodecane). In some embodiments, the C-11 alkane can be a structural or stereoisomer of dodecane, or mixtures thereof. In some embodiments, the C-13 alkane can be tridecane (i.e., n-tridecane). In some embodiments, the C-13 alkane can be a structural or stereoisomer of tridecane, or mixtures thereof. In some embodiments, the C-14 alkane can be tetradecane (i.e., n-tetradecane). In some embodiments, the C-14 alkane can be a structural or stereoisomer of tetradecane, or mixtures thereof. In some embodiments, the C-15 alkane can be pentadecane (i.e., n-pentadecane). In some embodiments, the C-15 alkane can be a structural or stereoisomer of pentadecane, or mixtures thereof. In some embodiments, the C-16 alkane can be pentadecane (i.e., n-hexadecane). In some embodiments, the C-16 alkane can be a structural or stereoisomer of pentadecane, or mixtures thereof.

In some embodiments, the composition comprises an aromatic hydrocarbon component. In some embodiments, the aromatic hydrocarbon component can comprise at least one aromatic hydrocarbon. As used herein, “aromatic hydrocarbon” means a compound that is an aromatic compound containing only carbon and hydrogen atoms. In some embodiments, the aromatic hydrocarbon can be benzene or a benzene derivative. In some embodiments, the aromatic hydrocarbon can be a mono- or poly-substituted benzene derivative. In some embodiments, the aromatic hydrocarbon can be a polycylic aromatic hydrocarbon. In some embodiments, the aromatic hydrocarbon can be selected from: benzene, toluene, ethylbenzene, xylene (and isomers thereof), mesitylene, durene, styrene, and mixtures thereof. In some embodiments, the aromatic hydrocarbon can be a benzene with any numbers of hydrocarbon substituents.

In some embodiments, the aromatic hydrocarbon component can comprise a mixture of benzene, toluene, ethylbenzene, and xylene (“BTEX”). In some embodiments, the aromatic hydrocarbon component can consist of a mixture of benzene, toluene, ethylbenzene, and xylene (“BTEX”). The xylene can be meta-, ortho-, or para-xylene, or any combination thereof. In some embodiments, the aromatic hydrocarbon component can comprise toluene and xylene. In some embodiments, the aromatic hydrocarbon can consist of toluene and xylene. In some embodiments, the aromatic hydrocarbon component can comprise toluene and ethylbenzene. In some embodiments, the aromatic hydrocarbon can consist of toluene and ethylbenzene.

In some embodiments, the composition can have a certain alkane component:aromatic hydrocarbon component ratio, which can be tailored to the specific environmental conditions in which it is being used. As discussed above, in some embodiments, the composition can be utilized in closed environments. In some embodiments wherein the composition can be utilized in closed environments, the alkane component:aromatic hydrocarbon component can be relatively higher than the alkane component:aromatic hydrocarbon component in compositions that can be utilized in open environments. Conversely, in some embodiments wherein the composition can be utilized in open environments, the alkane component:aromatic hydrocarbon component can be relatively lower than the alkane component:aromatic hydrocarbon component in compositions that can be utilized in closed environments.

In some embodiments, the alkane component:aromatic hydrocarbon component ratio is from about 1:4 to about 66:1. In some embodiments, the alkane component:aromatic hydrocarbon component ratio is from about 1:2 to about 66:1. In some embodiments, the alkane component:aromatic hydrocarbon component ratio is from about 5:6 to about 66:1. In some embodiments, the alkane component:aromatic hydrocarbon component ratio is from about 1:2 to about 30:1. In some embodiments, the alkane component:aromatic hydrocarbon component ratio is from about 1:2 to about 20:1. In some embodiments, the alkane component:aromatic hydrocarbon component ratio is from about 1:1 to about 20:1.

In some embodiments, the alkane component:aromatic hydrocarbon component ratio is from about 1:3 to about 22:1. In some embodiments, the alkane component:aromatic hydrocarbon component ratio is from about 86:9 to about 66:1. In some embodiments, the alkane component:aromatic hydrocarbon component is from about 10:1 to about 30:1. In some embodiments, the alkane component:aromatic hydrocarbon component is from about 10:1 to about 25:1. In some embodiments, the alkane component:aromatic hydrocarbon component is from about 10:1 to about 20:1. In some embodiments, the alkane component:aromatic hydrocarbon component is from about 15:1 to about 25:1. In some embodiments, the alkane component:aromatic hydrocarbon component is from about 18:1 to about 22:1. In some embodiments, the alkane component:aromatic hydrocarbon component is from about 19:1 to about 21:1.

In some embodiments, the alkane component can comprise more than one alkane, for example, the alkane component can comprise a C-5 and a C-6 alkane in a C-5 alkane:C-6 alkane ratio of from about 5:8 to about 10:13. In some embodiments, the C-5 alkane:C-6 alkane ratio can be from about 7:9 to about 9:11. In some embodiments, the C-5 alkane:C-6 alkane ratio can be from about 8:11. In some embodiments, the C-5 alkane:C-6 alkane:aromatic hydrocarbon component ratio can be from about 27:39:1 to about 37:49:9. In some embodiments, the C-5 alkane:C-6 alkane aromatic hydrocarbon component ratio can be from about 7:9:1 to about 9:11:1. In some embodiments, the C-5 alkane:C-6 alkane: aromatic hydrocarbon component ratio can be about 8:11:1. As described above, the C-5 alkane can be pentane and the C-6 alkane can be hexane.

In some embodiments, the aromatic hydrocarbon component can comprise one or more aromatic hydrocarbons. In some embodiments, the aromatic hydrocarbon component can comprise toluene and xylene. The toluene and xylene can be in a toluene:xylene ratio of from about 2:1 to about 3:2. In some embodiments, the toluene:xylene ratio can be from about 2:1 to about 5:4. In some embodiments, the toluene:xylene ratio can be about 3:1. In some embodiments, the aromatic hydrocarbon component can comprise toluene and ethylbenzene. The toluene and ethylbenzene can be in a toluene:ethylbenzene ratio of from about 3:2 to about 5:2. In some embodiments, the toluene:ethylbenzene ratio can be about 5:2. In some embodiments, the toluene:ethylbenzene ratio can be about 7:3 In some embodiments, the aromatic hydrocarbon component can further comprise benzene and ethylbenzene. In some embodiments, the ratio can be a toluene:xylene:benzene:ethylbenzene ratio of about 1:1:1:1.

In some embodiments, the composition can comprise an alkane component that can comprise a C-5 alkane, e.g., pentane, and a C-6 alkane, e.g. hexane, and an aromatic hydrocarbon component that can comprise toluene and xylene. In some embodiments, the pentane:hexane:toluene:xylene ratio can be about 8:11:1. In some embodiments, the aromatic hydrocarbon component can comprise benzene, toluene, ethylbenzene, and xylene. In some embodiments, the pentane:hexane:benzene:toluene: ethylbenzene:xylene ratio can be about 8:11:1:1:1.

In some embodiments, the composition is benzene free. One advantage of benzene-free compositions is that those compositions are more environmentally friendly and safer to humans and animals, as benzene is a known carcinogen.

In some embodiments, the density of the composition can be from about 500 kg/m3 to about 1000 kg/m³ .In some embodiments, the density of the composition can be from about 600 kg/m³ to about 700 kg/m³. In some embodiments, the density of the composition can be from about 700 kg/m³ to about 900 kg/m³. In some embodiments, the density of the composition can be from about 900 kg/m³ to about 1000 kg/m³. In some embodiments, the density of the composition can be from about 600 kg/m³ to about 675 kg/m³. In some embodiments, the density of the composition can be from about 650 kg/m³ to about 675 kg/m³. In some embodiments, the density of the composition can be about 663 kg/m³. In some embodiments, the density of the composition can be about 668 kg/m³. The density measurements can be based known density measurement methods, for example, ASTM D1298-99(2005) or ASTM D4052-11.

In some embodiments, the kinematic viscosity of the composition can be from about 0.4 cST to about 0.6 cST, as measured by ASTM D445 at 7.5° C. In some embodiments, the kinematic viscosity of the composition can be from about 220 cSt to about 320 cSt, as measured by ASTM [D445] at 36° C.

The inventors have surprisingly found that by using “like” chemicals, i.e., hydrocarbon-based chemicals, in viscosity reducing compositions for heavy oils and light oil condensate diluents, it can be possible to decrease the viscosity of heavy oils and decrease the density of heavy oils. Advantages include that in some embodiments, the compositions: (1) may not cause emulsions; (2) may not become inactive or molecularly decompose in the presence of heat or pressure; (3) may not change the pH of the heavy/crude oil or parent condensate; and (4) can be equally as non-corrosive as known condensates (diluents), e.g., polymer-based diluents, and the like. Additionally, the compositions do not contain ingredients such as carbon dioxane, sulfurs, ethers, polymers, DRAs, phosphorus, or mercaptan.

In some embodiments, the compositions can break apart certain substances, for example, when added to oil “plugs” containing asphaltenes, paraffin's and silicon the composition can break them apart within minutes (at ambient temperatures) and form a light oil that can be easy to manipulate. In some embodiments, the compositions can be added to certain known condensates, e.g., lean oils, to form a universal solvent.

In some embodiments, the compositions can be used in the gas and oil field. Some embodiments comprise utilizing the compositions to free or unclog pipe structure in which oil has stopped flowing due to high density materials. Some embodiments comprise utilizing the composition to clean heavy oil deposits (e.g., paraffin, asphaltenes, sulfur compounds, nitrogen compounds, chloride deposits, and the like) from light oil systems for example stabilizer or facing towers and process vessels. Some embodiments comprise utilizing the composition as a universal vessel cleaner. For example, the compositions can be utilized “down hole” to help free wells that have stopped flowing due to plugging in their upper structure due to hardening of paraffin's and asphatenes. The compositions can also be used as a “wash” to accelerate the removal of heavy oils from sand laden bitumens or as an agent to assist in the removal of waters from SAGD oils. Some embodiments comprise utilizing the composition in concentrate to enable better smart pigging of heavy oil pipelines.

Accordingly, in some embodiments, the composition can be an oil additive. In some embodiments, the composition can be an oil diluent. In some embodiments, the composition can be an oil vessel cleaner. In some embodiments, the composition can be a viscosity-enhancing composition. In some embodiments, the composition can be an oil viscosity enhancer. In some embodiments, the composition can be an oil pipeline transport enhancer. In some embodiments, the composition can be an oil well plug remover.

Some embodiments include methods for enhancing the viscosity of an oil, e.g., a crude oil, or a light oil condensate diluent, comprising contacting the viscosity-enhancing composition (as described herein) with an oil. In some embodiments, the oil can a crude oil, and the viscosity-enhancing composition can be contacted directly with the crude oil. The contacting can occur in a pipeline, or an any other vessel. In some embodiments, the viscosity-enhancing composition can be contacted with a light oil condensate diluent to form an enhanced-viscosity diluent. The enhanced-viscosity diluent can be added to a crude oil, e.g., a crude oil in a pipeline. Accordingly, some embodiments include enhancing oil pipeline transport.

### EXAMPLES

### Example 1

### C-5 Alkane+C-6 Alkane+BTEX Composition

Example 1 was formulated from typical grade chemical make large scale manufacturing as cost effective and similar to experimental conditions as possible. Example 1 contained the following raw materials: (1) Benzene: 99.96 ACS VWR, UN 1114; (2) Toluene: 99.9% Pure, Fisher Scientific Lot AD-9230-67; (3) Ethylbenzene: 99.8% Pure, Acros Organics Lot A0311317 (4)Xylene: Certified ACS 99.9% Pure, Fisher Scientific Lot 130072; (5) Pentane: 98% Pure, Acros Organics Lot B0516857 (Density@ 15C: 630.5 kg/m³/630.6 kg/ m³ Viscosity@ 7.5° C.: 0.43185 cST); and (6) Hexane: 99.9% Honeywell B& J Brand Multipurpose; (Density@ 15° C.: 673.5 kg/m³/674.0 kg/m³ Viscosity@ 7.5° C.: 0.56474 cST)

The BTEX (i.e., the aromatic hydrocarbon component) was made from four equal parts by volume of benzene: toluene: ethylbenzene: xylene in an ultra cold environment. Density@ 15 C: 869.0 kg/m3 Viscosity@ 7.5 C: 0.85241 kg/m3

The final Example 1 Composition:

TABLE 1
Example 1 Composition

| COMPONENT | ACTUAL (g) |
|---|---|
| cC5 | 39.0645 |
| nC6 | 55.9532 |
| BTEX | 4.9501 |
| TOTAL | 99.9678 |

The final Example 1 Composition Properties:

TABLE 2
Example 1 Composition Properties

| Property (Method) | Value |
|---|---|
| Density (ASTM D1298-99(2005)) | 662.90 kg/m³ |
| Density (AP) (ASTM D4052-11) | 663.00 kg/m³ |
| Viscosity @7.5° C. (ASTM D445) | 0.50346 cSt (MDL = 0.1) |

### Example 2

### C-5 Alkane+C-6 Alkane+TX Composition

Example 2 was formulated from typical grade chemicals to make large scale manufacturing as cost effective and similar to experimental conditions as possible. Example 2 is an exemplary benzene-free composition.

Example 2 contained the following raw materials: (1) Toluene: 99.9% Pure, Fisher Scientific Lot AD-9230-67; (2) Xylene: Certified ACS 99.9% Pure, Fisher Scientific Lot 130072; (3) Pentane: 98% Pure, Acros Organics Lot B0516857 (Density@ 15° C.: 630.5 kg/m³/630.6 kg/m³; viscosity@ 7.° 5 C: 0.43185 cST); and (4) Hexane: 99.9% Honeywell B& J Brand Multipurpose (99.9% Honeywell B& J Brand Multipurpose Density@ 15° C.: 673.5 kg/m3/674.0 kg/m3 Viscosity@ 7.5° C.: 0.56474 cST)

The final Example 2 Composition:

TABLE 3
Example 2 Composition

| COMPONENT | ACTUAL (g) |
|---|---|
| cC5 | 40.3558 |
| nC6 | 56.1077 |
| TX | 5.0541 |
| TOTAL | 101.5176 |

The final Example 2 Composition Properties:

TABLE 4
Example 2Composition Properties

| Property (Method) | Value |
|---|---|
| Density (AP) (ASTM D4052-11) | 662.20 kg/m³ |
| Viscosity 7.5° C. (ASTM D445) | 0.50728 cSt (MDL = 0.1) |

### Example 3

### Viscosity Reduction on Crude Oil Sample by Example 2 (Benzene-Free)

This example shows the viscosity-reducing capabilities of Example 2 on Peace River Blend crude oil sample. Peace River Blend has an initial density (before blending with Example 2) of 1015 kg/m³ and viscosity of 16557 cSt at 25° C.

TABLE 5
Peace River Blend + Example 2 Composition

| COMPONENT | ACTUAL (g) |
|---|---|
| Peace River Blend | 39.7080 |
| Example 2 | 10.2707 |
| TOTAL | 47.9787 |

TABLE 6
Peace River Blend + Example 2 Composition Properties

| Property (Method) | Value |
|---|---|
| Density (AP) (ASTM D4052-11) | 916.70 kg/m³ |
| Viscosity 7.5° C. (ASTM D445) | 214.90 cSt (MDL = 0.1) |

### Example 4

### Viscosity Reduction on Light Oil Condensate Diluent by Example 1

TABLE 7
Example 4 (CRW Condensate + Example 1) Composition

| COMPONENT | ACTUAL (g) |
|---|---|
| CRW Condensate | 35.6139 |
| Example 2 | 33.1946 |
| TOTAL | 68.8085 |

TABLE 6
Example 4 Composition Properties

| Property (Method) | Value |
|---|---|
| Density ASTM D1298-99(2005) | 698.10 kg/m³ |
| Density (AP) (ASTM D4052-11) | 699.20 kg/m³ |
| Viscosity 7.5° C. (ASTM D445) | 0.50226 cSt (MDL = 0.1) |
| Viscosity 7.5° C. (ASTM D445) | 0.50510 cSt (MDL = 0.1) |

### Example 4A

### Viscosity Reduction on Peace River Blend by Example 4

Upon 24% addition of Example 4, the density of the Peace River Blend was reduced from 1015 kg/m³ to 930 1015 kg/m³ and the viscosity was reduced from 16,557 cSt at 25° C. to 355 cSt at 15° C. A similar benzene free composition containing CRW condensate+Example 2 has shown a reduction in Peace River Blend by ˜70% with an addition of less than 12% product to the whole mixture. This means a pipeline could carry between 8-18% more oil and still have the same flow characteristics.

The above compositions (in Examples 1-4) were able to reduce the use of diluent by between 8-18%. By adding the composition to the condensate, a stable safe product was created. Considerations in the final composition may include vapor pressure, flash point, shipping temperature, safety issues or any environmental concerns specific to the implementation.

We claim:

1. A composition for reducing the viscosity of a fluid comprising:
an alkane component, the alkane component comprising at least one C-5 to C-7 alkane; and
an aromatic hydrocarbon component, the aromatic hydrocarbon component comprising at least one aromatic hydrocarbon;
wherein an alkane component:aromatic hydrocarbon component ratio is from about 5:6 to about 66:1.

2. The composition of claim 1, wherein the alkane component comprises a C-5 alkane and a C-6 alkane in a C-5 alkane:C-6 alkane ratio from about 5:8 to about 10:13

3. The composition of claim 2, wherein the C-5 alkane:C-6 alkane ratio is about 8:11.

4. The composition of claim 2, wherein a C-5 alkane:C-6 alkane:aromatic hydrocarbon component ratio is from about 27:39:1 to about 37:49:9.

5. The composition of claim 4, wherein the aromatic hydrocarbon component comprises toluene and xylene.

6. The composition of claim 5, wherein a C-5 alkane:C-6 alkane:toluene:xylene ratio is from about 27:39:2:1 to about 37:49:5:4.

7. The composition of claim 6, wherein a C-5 alkane:C-6 alkane:toluene:xylene ratio is about 8:11:3:1

8. The composition of claim 4, wherein the aromatic hydrocarbon component further comprises benzene and ethylbenzene.

9. The composition of claim 8, wherein a C-5 alkane:C-6 alkane:benzene:toluene:ethylbenzene:xylene ratio is from about 27:39:1:1:1:1 to about 37:49:2:2:2:2.

10. The composition of claim 9, wherein a C-5 alkane:C-6 alkane:benzene:toluene:ethylbenzene:xylene ratio is about 8:11:1:1:1:1.

11. The composition of claim 2, wherein the C-5 alkane is n-pentane and the C-6 alkane is n-hexane.

12. The composition of claim 2, wherein a density of the composition is from about 600 kg/m³ to about 700 kg/m³, as measured by either ASTM D1298-99(2005) or ASTM ASTM D4052-11.

13. The composition of claim 2, wherein a kinematic viscosity of the composition is from about 0.4 cST to about 0.6 cST, as measured by ASTM D445 at 7.5° C.

14. The composition of claim 1, further comprising a light oil condensate diluent.

15. A composition comprising:
pentane;
hexane; and
an aromatic hydrocarbon component, the aromatic hydrocarbon component comprising toluene and xylene;
wherein a pentane:hexane:toluene:xylene ratio is from about 27:39:2:1 to about 37:49:5:4.

16. The composition of claim 15, wherein the pentane:hexane:toluene:xylene ratio is from about 5:8:2:1 to about 10:13:3:2.

17. The composition of claim 16, wherein the pentane:hexane:toluene:xylene ratio is 8:11:3:1.

18. The composition of claim 15, further comprising benzene and ethylbenzene, wherein a pentane:hexane:benzene:toluene:ethylbenzene:xylene ratio is from about 27:39:1:1:1:1 to about 37:49:2:2:2:2.

19. The composition of claim 18, wherein the pentane:hexane:benzene:toluene:ethylbenzene:xylene ratio is about 8:11:1:1:1:1.
